(19) United States
(12) Patent Application Publication
(10) Pub. No.: US 2012/0242087 A1
(43) Pub. Date: Sep. 27, 2012

(54) Hollow Core Wind Turbine

(76) Inventor: Matthew Leo Ruder, Thatcher, UT (US)

(21) Appl. No.: 13/072,694

(22) Filed: Mar. 26, 2011

(51) Int. Cl. F03D 9/00

(52) U.S. Cl. 290/55

(57) ABSTRACT

A vertical axis wind turbine electrical energy generating system comprising a tower, a split vertical sleeve to which is affixed a wind vane assembly with an internal electrical generator, an electric controller and, in the preferred embodiment, a battery assembly for local storage of the generated electricity. The split sleeve allows the wind turbine assembly to be easily placed on existing or new towers or poles. The electricity generated can be fed to the electrical grid or remotely stored to power roadway or other public lighting.

### I. CROSS-REFERENCE TO RELATED APPLICATIONS

U.S. Pat. No. 756,372 April 1904 Johnson
U.S. Pat. No. 1,057,233 March 1913 DeGeofroy
U.S. Pat. No. 1,876,595 September 1932 Beldimano
U.S. Pat. No. 2,418,439 April 1947 Wetherill
U.S. Pat. No. 3,726,476 April 1973 Porter et al.
U.S. Pat. No. 3,944,839 March 1976 Carter
U.S. Pat. No. 4,088,419 May 1978 Hope et al.
U.S. Pat. No. 4,140,433 February 1979 Eckel
U.S. Pat. No. 4,156,579 May 1979 Weisbrich
U.S. Pat. No. 4,156,580 May 1979 Pohl
U.S. Pat. No. 4,184,084 January 1980 Crehore
U.S. Pat. No. 4,236,083 November 1980 Kenney
U.S. Pat. No. 4,288,199 September 1981 Weisbrich
U.S. Pat. No. 4,348,594 September 1982 Lipfert
U.S. Pat. No. 4,421,452 December 1983 Rougemont
U.S. Pat. No. 4,540,333 September 1985 Weisbrich
U.S. Pat. No. 4,708,592 November 1987 Krolick et al.
U.S. Pat. No. 4,725,194 February 1988 Bartsch
U.S. Pat. No. 4,764,683 August 1988 Coombes
U.S. Pat. No. 5,062,765 November 1991 McConachy
U.S. Pat. No. 5,137,417 August 1992 Lund
U.S. Pat. No. 5,313,103 May 1994 Hickey
U.S. Pat. No. 5,520,505 May 1996 Weisbrich
U.S. Pat. No. 6,015,258 January 2000 Taylor
U.S. Pat. No. 6,132,172 October 2000 Li
U.S. Pat. No. 6,158,953 December 2000 Lamont
U.S. Pat. No. 6,278,197 August 2001 Appa
U.S. Pat. No. 6,519,901 February 2003 Nelson
U.S. Pat. No. 6,626,638 September 2003 Rosefsky
U.S. Pat. No. 6,966,747 November 2005 Taylor et al.
U.S. Pat. No. 7,540,706 June 2009 Rashidi
U.S. 2002/0180216 December 2002 McDavid
U.S. Pat. No. 7,550,865 June 2009 Jonsson
U.S. Pat. No. 7,665,966 February 2010 Warszewki
U.S. Pat. No. 7,679,209 March 2010 Rashidi
U.S. Pat. No. 7,863,765 January 2011 Yang
U.S. Pat. No. 7,874,787 January 2011 Morris
U.S. 61/318,289 March 2010 Ruder

### II. STATEMENT REGARDING FEDERALLY SPONSORED RESEARCH OR DEVELOPMENT

There are no rights to this invention, or anything pertaining to said invention, which has been federally or otherwise sponsored or developed in anyway.

### III. FIELD OF THE INVENTION

This invention relates to wind turbine devices, and more particularly to a vertical-axis wind turbine device with an internal, generator and electrical control system designed to be affixed onsite to the tower/pole that constitutes the vertical axis. This invention can serve as a means of gerierating and/or storing electricity anywhere there is already a streetlight or other structure to which it can be attached. The invention can also be used in remote locations to power street lamps, other public lighting and/or other local electrical devices.

### IV. BACKGROUND OF THE INVENTION

This invention is in reference to, and claims priority to, provisional patent application number 61/318,289 filed by Matthew L. Ruder. Traditional wind turbines require their own real estate, their own pole, and new electrical infrastructure. Most available wind turbine designs also have problems of excessive noise and vibration and require separate start-up, braking or stopping mechanisms.

There has been an ongoing need for a wind turbine design that can be successfully incorporated into various building and tower structures, that produces minimal noise and vibration during operation, is capable of starting up and operating in each of low speed, steady, gusty, and high speed wind conditions. This invention allows power poles, light poles, billboard support poles, water towers, or other pole type structures to be used as support structures for an electrical turbine system. This will tremendously reduce the cost of installing a wind turbine due to the fact that the real estate, pole, and electrical infrastructure are already in place. Application of this new technology will greatly increase the amount of renewable energy harvested.

### V. BRIEF SUMMARY OF THE INVENTION

The hollow core wind turbine (HCWT) rotates upon a vertical axis. In the inner surface of the turbine an electrical generator is affixed. The magnet structure of the generator rotates with the turbine and the coils are secured to the pole. In the preferred embodiment the turbine uses traditional bearings or traditional split bearings to support the rotating frame. In an alternative embodiment the turbine utilizes magnetic levitation technology to support the rotating frame.

In the preferred embodiment the turbine is “split” in half so it can be clamped around a pole. Once clamped around the pole, it is secured. With this “split” design, it enables the turbine to be installed without disassembling or dismounting the pole. In an alternative embodiment the hollow core turbine would not be split, but could be fitted from the top or bottom of a pole.

### VI. BRIEF DESCRIPTION OF THE DRAWINGS

The means by which the foregoing and other aspects of the present invention are accomplished, and the manner of their accomplishment, are depicted in the following figures:

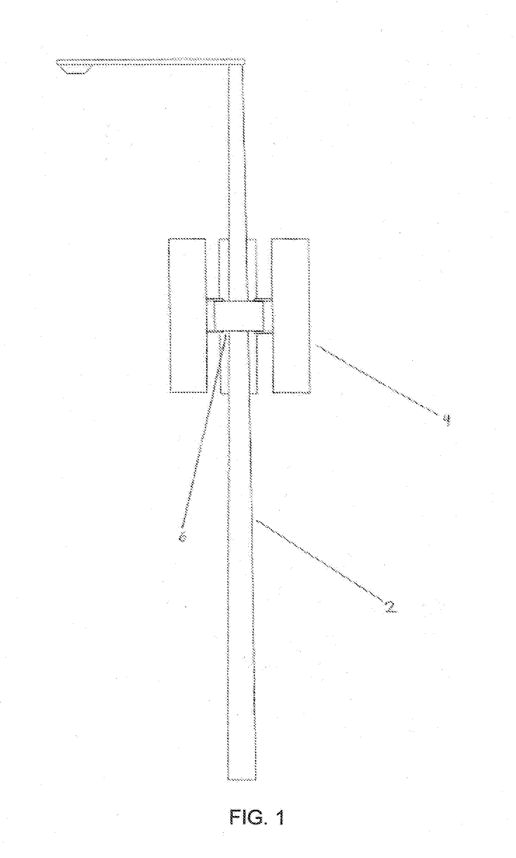

FIG. 1 Assembled HCWT attached to a pole.
2—Typical street light/pole
4—Air foil
6—Generator unit

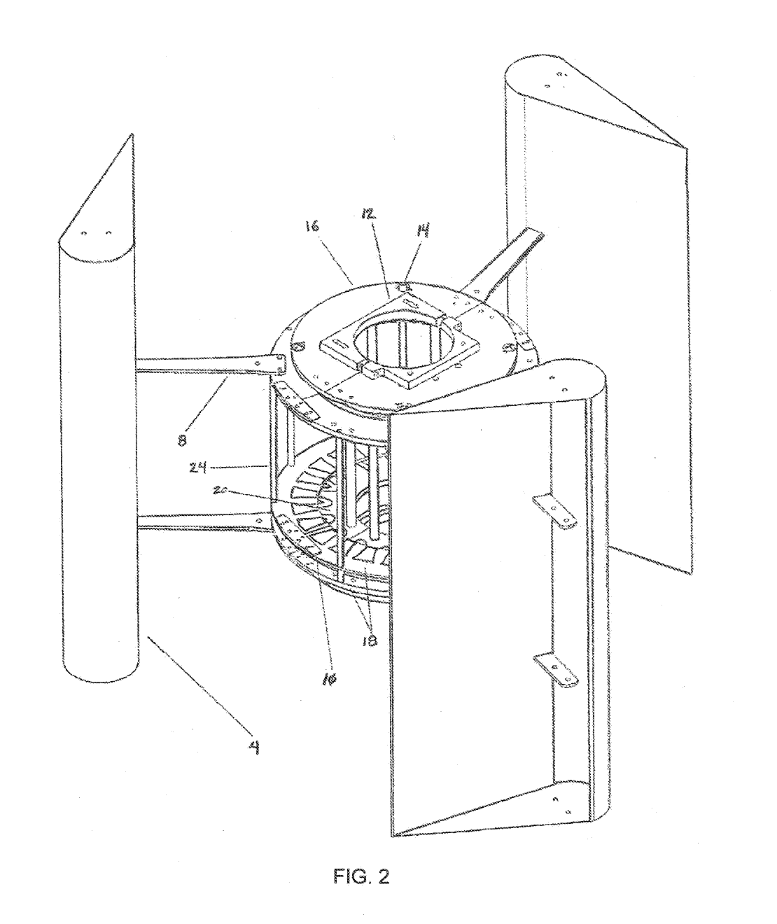

FIG. 2 Skeletal view of HCWT
4—Air foil
8—Spoke
10—Rotor assembly joint key
12—Clamp collar
14—Bearing
16—Fixed mount
18—Rotor
20—Stator
24—Support rod

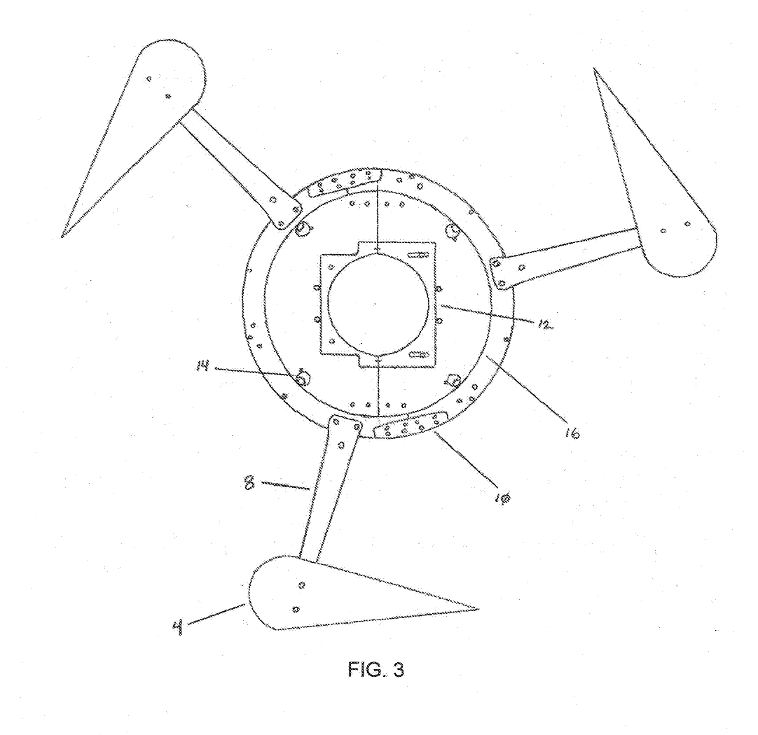

FIG. 3 Top view of HCWT
4—Air foil
8—Spoke
10—Rotor assembly joint key
12—Clamp collar
14—Bearing
16—Fixed mount

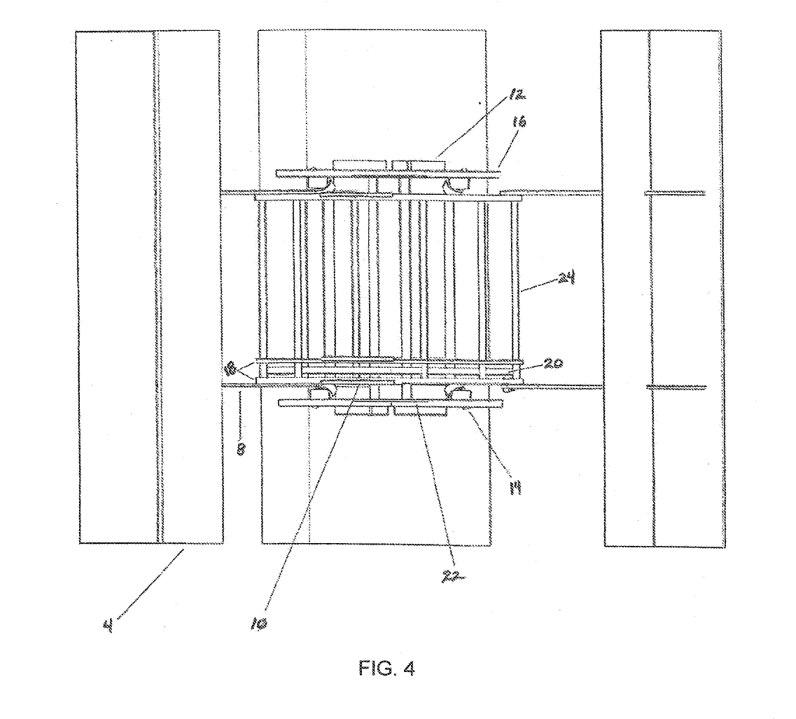

FIG. 4 Side view of HCWT
4—Air foil
8—Spoke
10—Rotor assembly joint key
12—Clamp collar
14—Bearing
16—Fixed mount
18—Rotor
20—Stator
22—Fixed mount joint key
24—Support rod

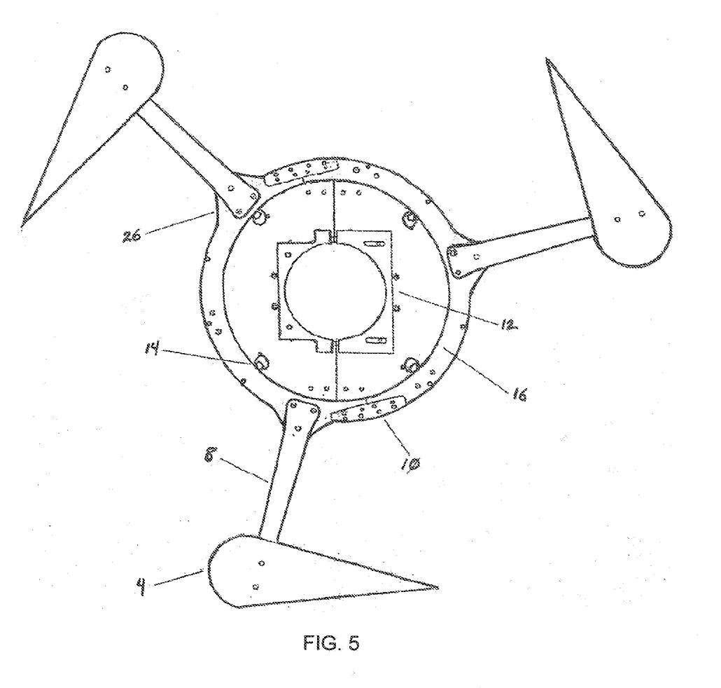

FIG. 5 Top view of HCWT with reinforced spoke attach point
4—Air foil
8—Spoke
10—Rotor assembly joint key
12—Clamp collar
14—Bearing
16—Fixed mount
26—Reinforced spoke mount

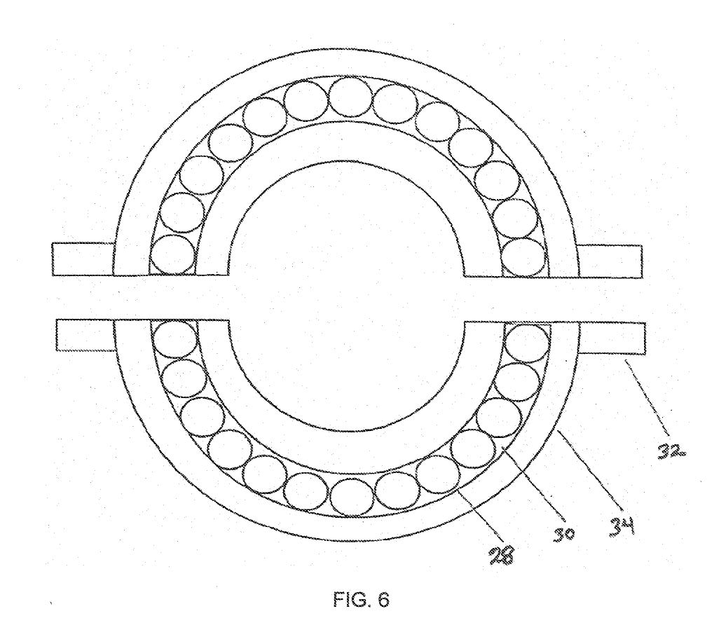

FIG. 6 Top open view of split bearing alternative
28—Roller ball
30—Channel within race
32—Flange
34—Race enclosure

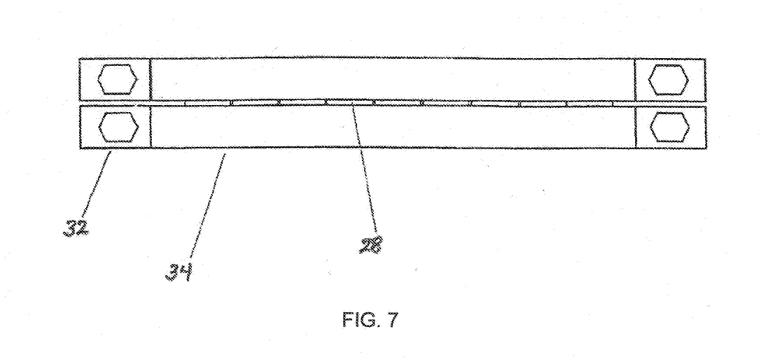

FIG. 7 Side view of assembled split bearing alternative
28—Roller ball
32—Flange
34—Race enclosure

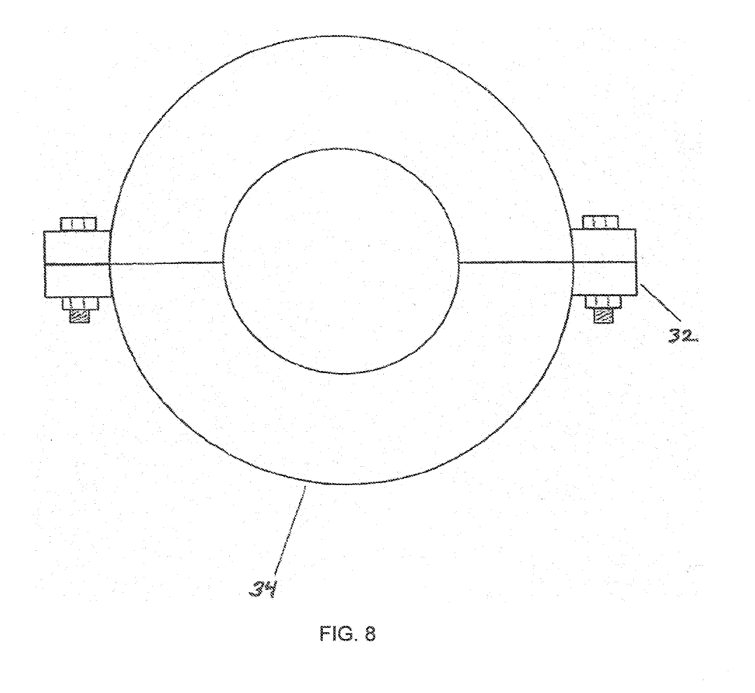

FIG. 8 Assembled top view of split bearing alternative
32—Flange
34—Race enclosure

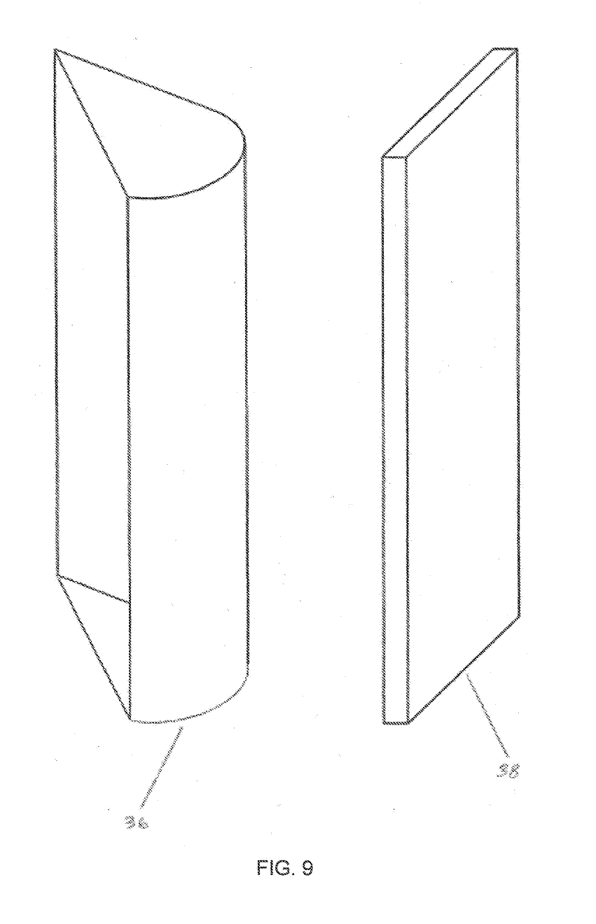

FIG. 9 Types of airfoils A
36—Lift or “wing” type airfoil
38—Drag or “Giromill” type airfoil

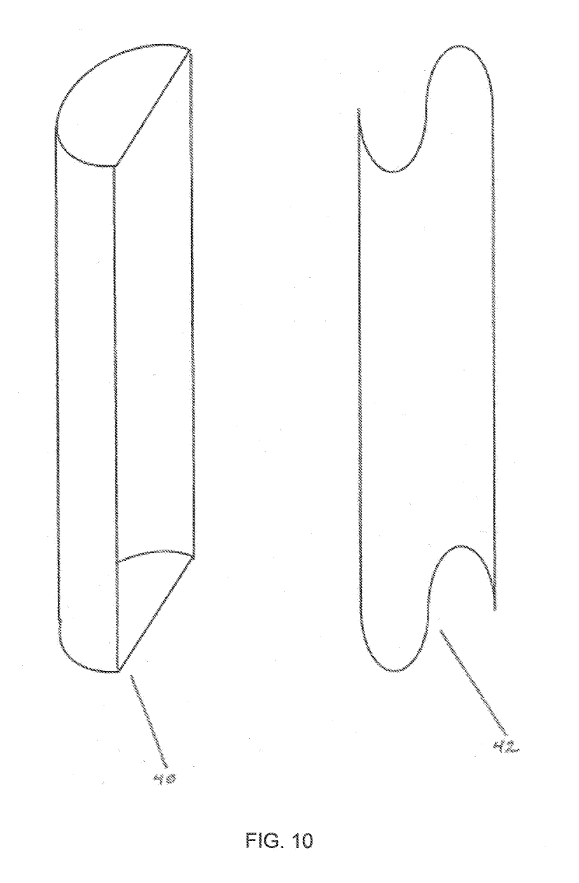

FIG. 10 Types of airfoils B
40—Savonius type airfoil
42—Helix type airfoil

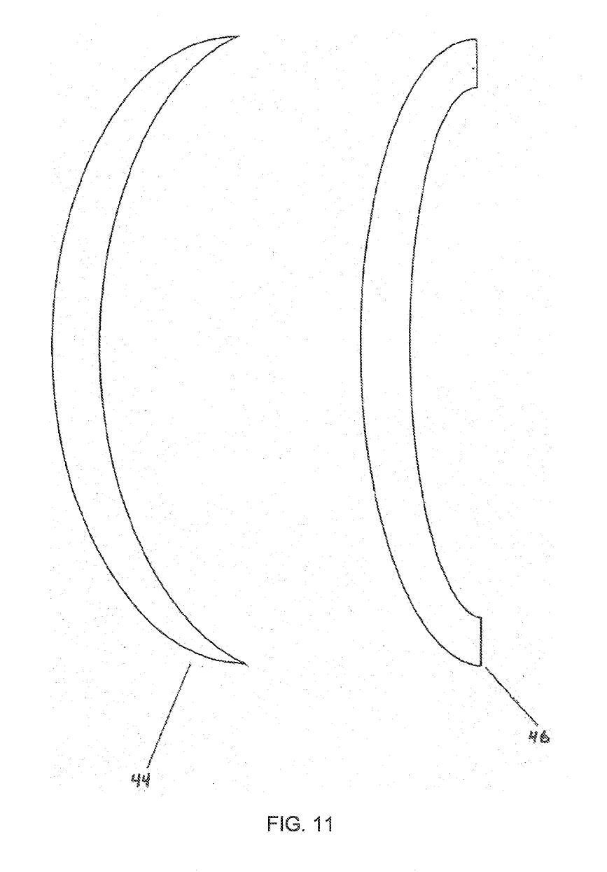

FIG. 11 Types of airfoils C
44—Darrieus type airfoil
46—Variation of Darrieus type airfoil

### VII. DETAILED DESCRIPTION OF THE INVENTION

Having reference to the drawings, wherein like reference numerals indicate corresponding elements, there is shown in FIGS. 1 through 11, a wind turbine device forming various embodiments of the present invention, namely a “split hollow core” wind turbine.

Item 2 is an example of a typical street light seen throughout the world. This is an example of the type of structure to which this invention could be attached.

Item 4 is an example of a type of vane, or wing, or air foil, or other term for a wind catching structure which would cause this wind turbine to spin.

Item 6 is a depiction of the outer casing which encloses the inner workings of the electrical generating device within this invention.

Item 8 is a spoke which attaches the vane (as described in item 4) to the electrical generating device. The spoke confers the energy from the wind to cause the electrical generating device to spin, thusly generating electricity.

Item 10 is the rotor assembly joint key which connects and secures the two halves of the rotating mass.

Item 12 is the clamp collar which connects and secures the two halves of the fixed mount which supports the bearings and stator.

Item 14 is one of the eight bearings supporting the rotating mass of the embodiment of FIG. 2. It is also depicted in FIGS. 3, 4, and 5.

Item 16 is the joint mount plate to which supporting rods, bearings, and the stator is attached. This unit is affixed to the pole or other structure and the rotating mass rotates around this fixed structure.

Item 18 is the rotor which consists of two discs (which are technically four half discs which form two when assembled). This assembly forms a dual rotor with opposing magnetic poles. When assembled, the preferred embodiment in this filing is a dual core, axial flux alternator. It is possible and feasible that a single core axial flux alternator is used, as well as the gear driven generator/alternator embodiments. There are many possible embodiments. Belt driven embodiments are possible as well.

Item 20 is the stator which consists of (when assembled as two halves) 18 coils of 15 gauge, insulated, copper wire, wound in an optimized shape of 70 turns in order to maximize the magnetic properties of a specifically trapezoidal shaped magnet which form the poles which create the optimal electrical current for this application. It is possible that after further study, a different number of turns in the coils, different gauge wire, number of coils, number of magnets within the rotors, will increase the electrical output.

Item 22 is the fixed mount joint key which joins the two halves of the structure in order to secure it to the structure to which it is attached.

Item 24 is the support rod which connects the top and bottom fixed and rotating halves of the depicted embodiment.

Item 26 is a depiction of a reinforced spoke mounting area of the current embodiment.

Item 28 is a depiction of a roller ball which is typically used in a ball bearing.

Item 30 is a channel which is the reciprocal shape of item 28 which has been created in order for item 28 to roll freely.

Item 32 is a flange created in order to join the separate halves of item 34.

Item 34 is the race enclosure which is the supports the bearing function.

Item 36 is a lift type of airfoil used to catch the wind and rotate the unit. This type of airfoil may vary greatly in size, shape, and design.

Item 38 is a drag type of airfoil used to catch the wind and rotate the unit. This type of airfoil may vary greatly in size, shape, and design.

Item 40 is a Savonius type of airfoil used to catch the wind and rotate the unit. This type of airfoil may vary greatly in size, shape, and design.

Item 42 is a helix type of airfoil used to catch the wind and rotate the unit. This type of airfoil may vary greatly in size, shape, and design.

Item 44 is a Darrieus type of airfoil used to catch the wind and rotate the unit. This type of airfoil may vary greatly in size, shape, and design.

Item 46 is a Darrieus type of airfoil used to catch the wind and rotate the unit. This type of airfoil may vary greatly in size, shape, and design.

1. A hollow core wind turbine, comprising: a split cylindrical rotatable sleeve constituting a frame to which are detachably mounted vanes consisting of airfoils or other air deflecting structures, wherein the vanes extend parallel to the axis of rotation of the rotatable frame, and wherein, the cylindrical frame has an electrical generator affixed to the inner surface of the frame, wherein the generator has a split hollow core so that the frame and generator system can be affixed to a vertical axis including existing or new poles, such as telephone, power transmission or light poles. In an alternative embodiment, the sleeve would not be split, but would be installed by placing it over the top of a new or existing pole.

2. The electrical power generating system of claim 1 with one or more internal bearings consisting of upper moveable and lower fixed circular tracks with track wheels or ball bearings annularly disposed to roll between the tracks upon which the structural load of the split sleeve assembly is suspended

3. The electrical power generating system of claims 1 and 2 in which an electrical generator and an electric controller are housed either within, below, or above the split sleeve.

4. The electrical power generating system of claims 1, 2 and 3 wherein the bearing system consists of magnets distributed around a circular track with the magnets of the fixed track arrayed so that their charge is opposite that of those on the movable track so that the magnet force serves to create a layer of air on which the structure can rotate.

5. The electrical power generating system of claims 1, 2 and 3 wherein the vanes are constituted of a solid material such as aluminum or some other metal or of a synthetics material such as graphite or of flexible shells comprised of fabric stretched around a substantially rigid frame.

6. The electrical power generating system of claims 1, 2, 3 and 5 wherein the vanes are of an “S” or Savonius shape or of other curvatures such as a Darrieus shape.

7. The electrical power generating system of claims 1, 2 and 3 wherein the turbine and vanes are fixed in position relative to each other.

8. The electrical power generating system of claims 1, 2 and 3 wherein the vanes can be automatically positioned in an optimized wind flow path.

9. The electrical power generating system of claims 1, 2 and 3 wherein the split sleeve is aligned through pins that allow the two halves of the sleeve to be assembled onsite.

10. The electrical power generating system of claims 1, 2 and 3 wherein the two halves of the split sleeve are aligned through pins that allow the two halves of the sleeve to be assembled onsite.

11. The electrical power generating system of claims 1, 2, 3 and 10 wherein the two halves of the split sleeve are affixed to each other through screws that allow the two halves of the sleeve to be assembled onsite.

12. The electrical power generating system of claims 1, 2, 3, 10 and 11 wherein the two halves of the bearing track(s) within the split sleeve are affixed to each other through screws that allow the two halves of the tracks to be assembled onsite.

13. The electrical power generating system of claims 1, 2, 3, 10, 11 and 12 wherein the assembled halves of the bearing track(s) within the split sleeve are affixed to the pole or tower by affixing to the pole a variable diameter inner sleeve or collar and/or L shaped brackets with a variable distance between them which are affixed to the fixed bearing track, so that the fixed bearing tracks can be assembled onsite.

14. The electrical power generating system of claims 1, 2, 3, 10, 11, 12 and 13 wherein the electrical controller is configured so that it can be connected directly to an existing electrical transmission system.

15. The electrical power generating system of claims 1, 2, 3, 10, 11, 12 and 13 wherein the electrical controller is configured so that it can be connected to a battery array or other storage system such as a slow discharge capacitor so that it can be used to power a light or other electrical device attached either to or proximate to the pole or tower used as the axis for the wind turbine.

16. The electrical power generating system of claims 1, 2, 3, 10, 11, 12 and 13 wherein the electrical generator consists of magnets attached to a platen which is affixed to the sleeve frame so that the magnets rotate around or through a copper core of fixed coils that are attached to the fixed bearing track,

17. The electrical power generating system of claims 1, 2, 3, 10, 11, 12, 13 and 16 wherein the system has a means of detecting wind speed. At a predetermined wind speed the electrical generator is automatically switched to be used as a motor to power the turbine until the rotation speed consistent with the wind speed is reached. Once the optimized rotation is reached, the generator is automatically switched back to serve as a generator.
